(19) United States
(12) Patent Application Publication
(10) Pub. No.: US 2009/0212140 A1
(43) Pub. Date: Aug. 27, 2009

(54) System and method for processing hygroscopic materials

(75) Inventor: Douglas P. Ritzenthaler, Columbus, OH (US)

Correspondence Address: AMERICAN ELECTRIC POWER COMPANY;C/O ANTHONY J. SWANECK, 1 RIVERSIDE PLAZA, 29TH FLOOR, COLUMBUS, OH, 43215, US

(73) Assignee: American Electric Power Company, Inc., Columbus, OH (US)

(21) Appl. No.: 12/378,830

(22) Filed: Feb. 20, 2009

Related U.S. Application Data
(60) Provisional application No. 61/067,222, filed on Feb. 26, 2008.

(51) Int. Cl. B02C 23/18; B02C 23/08; B02C 23/24

(52) U.S. Cl. 241/17; 241/18; 241/24.1; 241/65; 241/68

(57) ABSTRACT

The present invention is a system and method for reducing the size of a hygroscopic material while simultaneously drying the material at a relatively low temperature to a predetermined value during the reduction process. The present invention utilizes a preconditioning make-up air system to significantly dehumidify the make-up air to values in the range of 0.02 grains per pound of dry air while limiting the temperature of the make-up air exiting the preconditioning make-up air system to below a predetermined critical value. While not limited in its application to any one particular hygroscopic material, the present invention is particularly adapted to uses where the product is a temperature-sensitive, water adsorbing material such as sodium sesquicarbonate or trona ore.

The present application claim the benefit of U.S. Provisional Application No. 61/067,222 filed Feb. 26, 2008 and incorporated herein by reference in its entirety.

### BACKGROUND OF THE INVENTION

The system and method of the present invention relates generally to the processing of hygroscopic materials for delivery to a dry injection system, wherein the hygroscopic materials have an affinity for the addition of moisture and are temperature sensitive such that conventional drying techniques involving use of high temperatures are prone to initiate thermal damage to the product that is detrimental to its end-use performance. More specifically, the present invention is a system and method of rapidly milling, drying, and conveying a temperature sensitive hygroscopic material for delivery to an end-use point by a pneumatic based dry sorbent injection system.

Within the scope of this discussion, hygroscopic materials are those materials that exhibit one or more of the following three characteristics: (1) adsorb water vapor; (2) chemically react with water; or (3) have an affinity for water (vapor or liquid) at very low material free moisture levels (below 0.05% by weight free moisture).

For purposes of illustration, sodium sesquicarbonate, or trona ore, are used in the following discussion as representative of the characteristics and challenges found in the processing of temperature sensitive hygroscopic materials. Such usage is merely illustrative and to aid in the clarity of the discussion, and is not intended in any manner to limit the application of the present invention to any specific materials.

Hygroscopic materials, such as sodium sesquicarbonate or trona ore, while not truly chemically hygroscopic, exhibit many of the same characteristics of a hygroscopic material due to their affinity to adsorb moisture. Recent advances in acid gas mitigations technology, such as discussed in U.S. Published Patent Application 20050201914, have made use of these hygroscopic materials to remove acid gas constituents formed as a by-product of the combustion of fossil fuels. While particularly suited for acid gas mitigation processes when milled to a particle size on the order of D₅₀ less than approximately 100 microns, sodium sesquicarbonate and trona ore present substantial material handling challenges, especially outside of the arid climates of the desert southwest, due to their hygroscopic affinity to adsorb moisture from the surrounding air. This leads to the undesirable tendency of the extremely small particles to join together forming agglomerations that collect in and foul the material handling system.

In addition to use in applications requiring an extremely small particle size and an extremely low free moisture levels, sodium sesquicarbonate, or trona ore, can be rendered less effective for certain applications, such as acid gas mitigation, if exposed to temperatures much greater than 150 degrees Fahrenheit prior to introduction into the end-use process. The combination of limiting factors comprising small particle size, low free moisture levels, and extreme temperature sensitivity renders traditional milling and drying methods ineffective. Complicating matters further is the need in some application to have essentially real-time processing of the sodium sesquicarbonate, or trona ore, necessitating a rapid drying of the material, a process typically accomplished, as discussed below, by the introduction of high temperature gases into the milling process.

Trona ore is a naturally occurring sodium sesquicarbonate found throughout the world, including various places within the United States. The vast majority of mined trona ore is processed into soda ash. In the soda ash process, the trona ore is heated in a kiln until it liberates carbon dioxide (CO₂) and chemically bound water (H₂O); this is by definition the calcination of the product. Although the vast majority of the trona ore is calcined to produce soda ash, some secondary applications exist where trona powder is the end product. Cattle feed is one such application where trona ore must be milled to a powder, yet particle size is not critical.

A tertiary application of trona ore is as a sorbent for acid gas scrubbing in flue gas from industrial and utility boilers and other combustion or industrial processes. Dry sorbent injection of trona ore for SO₂ acid gas neutralization has been demonstrated since the 1970's. More recently, dry sorbent injection of trona ore for control of SO₃ and other strong acids has also been demonstrated. When trona ore is employed as a sorbent for dry sorbent injection, it is typically delivered to the end user as a fine, dry powder and injected into a flue gas duct or other environmental discharge stream. Key variables for successful use of this application include: extremely small particle size (D₅₀ less than about 15 microns), extremely low free moisture (less than or equal to 0.04% by weight for trona ore), and no thermal damage, which in the case of trona ore means no calcination, either partial or complete, due to high temperature exposure.

Calcination of trona ore is known to occur at very low temperatures relative to other minerals. For example, limestone (calcium carbonate) begins to calcine (liberates CO₂) at approximately 1,648 degrees Fahrenheit, with typical kiln temperatures of about 2,000 to 2,400 degrees Fahrenheit. Trona ore, however, begins to calcine at about 110 to 150 degrees Fahrenheit—depending upon exposure time. Rapid calcination of trona ore powder can occur when exposed to temperatures at or above about 170 degrees Fahrenheit. After trona ore liberates its CO₂ and H₂O during calcination, the chemical soda ash remains. Comparing the calcination temperatures of trona ore versus a typical ore like limestone, one can conclude that it is important to maintain trona ore below its calcination temperature. Other materials can be temperature sensitive for other reasons. For example, certain hygroscopic plastics must be maintained below their melt temperature to avoid product damage.

The reason that trona ore must not degrade into soda ash before when used for dry sorbent injection applications is due to the advantages that calcination provides when it is delayed until the trona ore is introduced into the end-use process. In the case of acid gas mitigations systems, this is after introduction into the gas stream containing the acid gas to be removed. If the trona ore calcines rapidly, as it does above about 250 degrees Fahrenheit, the trona ore particles rapidly decrepitate into smaller particles generating new pores and providing even more surface area for the acid-base reaction to occur. One skilled in the art would understand the need for obtaining the smallest particle size practically achievable to optimize dry scrubbing performance. Depending upon exposure time, accidental exposure of trona ore to high temperature (above about 110 to 150 degrees Fahrenheit) could result in a change in chemistry (the trona ore calcines thereby releasing CO₂ and H₂O vapor) resulting in the trona ore being transformed into soda ash (Na₂CO₃). Gradual calcination does not allow for decrepitation of the particle and the pores generated during calcination can collapse well before the material is placed in the presence of the acid gas to be scrubbed. Hence calcination prior to introducing the particle to the acid gas is detrimental to the reactivity of the trona ore when it is being employed as a dry sorbent, as calcined trona ore, namely soda ash, is essentially inert as a dry sorbent.

As those knowledgeable in the art of dry sorbent injection are aware, small particle size (large surface area) is a primary variable that impacts sorbent reactivity. The larger the surface area of the sorbent delivered (i.e., the smaller the particle size) the more reactive the sorbent will be, assuming all other variables are held constant. The challenge with employing small particle size is, in general, the negative effect on material handling equipment, especially storage silos. It is well known that high free moisture can exacerbate material flow problems related to small particle size. Some materials, such as trona ore, begin to adsorb moisture from the air after being milled to a fine powder (D₅₀ less than approximately 100 microns). Such adsorption of moisture often results in agglomerating of the sorbent resulting in the fouling of the material handling equipment.

The method typically employed for processing trona ore into a fine powder begins at the mine where the trona ore is initially mined and crushed to a manageable size and then brought to the surface where its is then further reduced in size utilizing a milling process to reduce the trona ore to a powder while maintaining the temperature of the trona ore generally at or below 120 degrees Fahrenheit. At this point in the process, use of extended residence time to dry the trona ore are acceptable; therefore, these relatively low temperatures are generally acceptable for driving off free moisture while being low enough to avoid thermal damage to the product.

After the trona ore is reduced to a powder, it is sent through screens or other classifying equipment to recycle over-sized product back into the milling process. During this classification process the trona is exposed to process air that carries with it a significant amount of water vapor. If the relative humidity of the process air exceeds about 50%, the trona ore can adsorb water vapor, increasing its free moisture content. The trona ore passes through the screens or other classifying equipment is then sent to a secondary drying process, such as a fluidized bed drier, for free moisture reduction. The fluidized bed drier (or other drying equipment) may also be used for secondary classification and/or product beneficiation. The peak temperature of the secondary drying process is maintained below the temperature where thermal damage can occur. Process experience dictates the maximum peak temperature that can be employed while avoiding thermal damage. Peak temperatures are typically maintained at or below 120 degrees Fahrenheit but this can vary based on optimizing both the residence time and peak temperature to minimize drying rates.

A controlled cooling of the powdered trona ore is conducted before it enters a pneumatic conveying, or other material handling process. This controlled cooling protects the powder from re-adsorbing water vapor as is typical when rapid cooling occurs in the open atmosphere. Beneficiation may also be employed during and/or between some of these steps. The equipment for size reduction, however, is distinct from the equipment for drying.

It has been demonstrated that hygroscopic materials can be difficult to handle when the free moisture is high. For trona ore, material handling problems can occur if the free moisture content exceeds about 0.04%. Free moisture content in the material over 0.04% has been observed to increase cohesiveness and thereby degrade flow characteristics in bulk vessels such as silos. Trona ore is a material with a relatively high cohesive nature even when dried below 0.01% free moisture. When free moisture reaches 0.05% material flow characteristics have been observed to change significantly. An increase in cohesiveness occurs, lending itself to bridge or rat hole, among other material handling problems.

Although trona ore is not chemically hygroscopic, it has been observed that after the ore is milled, the small particles (D₅₀ less than approximately 100 microns) do tend to adsorb water vapor. Other materials may also exhibit this behavior as well. Furthermore, many other materials are chemically hygroscopic, that is, chemically reactive with water vapor. Although the trona ore powder does not chemically react with water, the finely milled trona ore powder has been observed to adsorb water due to the combined effects of the large surface area of the material after it is milled to a fine powder along with its very low free moisture level.

Drying time often becomes the critical path for the milling process. Laboratory tests indicate that at temperatures as high as 140 degrees Fahrenheit, completely drying of ¼ inch top size trona ore (0.00% final free moisture or 0.67% free moisture driven off the product) can take over seven minutes. Similar tests found that it can take as long as 6.5 minutes to obtain free moisture of about 0.04%.

A common practice outside of the trona ore industry is for many ores to be milled and dried in one step. For example, this is commonly done with limestone, magnesite, and various other ores. However, the drying step involves elevating the material temperature to drive off the free moisture. This is typically accomplished utilizing a high temperature gas stream, generally in the range of about 250 to 450 degrees Fahrenheit. The high temperature liberates free moisture from the product and one is left with hot, dry product being sent to a storage silo.

Referring to FIG. 1, a typical reducing mill system with hot make-up air 100 is illustrated. Reducing mill 140 comprises material feed inlet 145 through which the raw material enters and is directed to reducing mill body 150. Within reducing mill body 150 the reduction process takes place by various methods depending on the type of reducing mill in use, but in generally involves reducing or milling the raw material through a mechanical process of grinding, pulverizing, impacting, shredding, or crushing to produce a finished product of predetermined particle size. Reducing mill 140 is additionally equipped with classifier 155, configured so as to sort the milled raw material and discharged properly sized particles through reducing mill outlet 157 as finished product. Oversized particles are recycled back to the lower reducing mill body 150 where they are reintroduced into the milling or reducing process.

Transport of the raw material and the finished product through reducing mill 140 is accomplished through the use of mill process air, which entered reducing mill 140 at mill process air inlet 153 and is directed to reducing mill body 150. Within reducing mill body 150, the circulated mill process air mixes with the raw material during the reducing or milling process serving to agitate the raw material, ensuring all of the raw material is eventually exposed to the reducing or milling process. The circulated mill process air also provides the transport mechanism for delivering the finished product from reducing mill 140 to the next stage in the process by way of reducing mill outlet 157. Accordingly, the rate at which make-up air is supplied to reducing mill 140 to replace the mill process air must be at least sufficient to entrain the particle of finished product and to carry such finished product through optional classifier 155 and out of reducing mill 140 by way of reducing mill outlet 157.

In an arrangement wherein the raw material is to be both milled or reduced and undergo a substantial reduction in free moisture, the relative humidity of the circulated mill process air entering the reducing mill is critical. Referring again to FIG. 1, make-up air to reducing mill 140 begins as ambient air that is then directed to heater 110 where the make-up air is preheated, raising its temperature to between 250 to 450 degrees Fahrenheit. By raising the temperature of the make-up air, the relative humidity of the make-up air decreases significantly. This allows the raw material to liberate moisture as it is milled resulting in drying of the raw material during the milling or reducing process. In most instances, pre-heating the make-up air to facilitate the drying of the raw material is an acceptable process because the raw material does not react, change form, or become damaged at the temperatures at which the make-up air is preheated. Such is not the case with many temperature sensitive materials, such as sodium sesquicarbonate, or trona ore. With these materials, the temperatures to which unconditioned ambient air must be heated in order to accomplish drying of the raw material within the reducing mill exceed the temperature at which the material itself undergoes the chemical reaction known as calcination.

Following the milling or reducing process, the finished product is carried by the make-up air from reducing mill 140 by way of a closed transport line to a material/air separator such as cyclone separator 160. Typically, at least 90-95% of the material drops out of the air stream to the bottom of cyclone separator 160, while the air and some residual material is recycled back to process fan 170. Control damper 175 modulates the air flow to maintain constant flow to reducing mill 140. At the process fan 170 outlet, a duct directs a slip stream to baghouse 180. Thermocouple 172, monitors process temperature and may be used to control make up air temperature. A second particle/air separation device such as baghouse 180 (also known in the industry as a fabric filter) is used to remove any remaining material (dust) from the air stream before it is discharged by way of baghouse fan 185 to the atmosphere through Stack 190. Compressed air 187 is used periodically to clean the bags. An alternate means of cleaning the fabric filter bags would be the employment of shakers. Another alternate means of cleaning the fabric filter bags would be employing dampers to change flow direction such that reverse flow is used.

Material that drops out of the air stream either in cyclone separator 160 or baghouse 180 pass through air locks 165 and 186 to the pneumatic conveying line 125. Alternate arrangements could have the material drop into packaging or bagging equipment. Transport air is provided to pneumatic conveying line 125 by way of pneumatic conveying blower 122. The finished product is then transported to bulk storage vessels 181, such as silos or trucks. Typically, the processing rate (throughput) through reducing mill 140 is governed by pressure drop across reducing mill 140 and its power consumption. Steady state conditions are achieved by establishing a constant feed and by modulating control damper 175 to maintain constant air flow to reducing mill 140.

Hygroscopic materials such as calcium chloride are also milled and dried using high temperatures to drive off the free moisture. This can be accomplished in one or two steps. Materials such as trona ore that are temperature-sensitive cannot be milled and dried utilizing such a high temperature process due to the exposure to temperatures that damage the product's chemistry or reactivity. Drying of certain hygroscopic products, such as plastics resins (nylon, acrylonitrile butadiene styrene or ABS, polyethylene terephthalate or PET), also employ high heat (nominally 300 degrees Fahrenheit) to dry the product in hot air dryers or other drying equipment. Desiccated air is employed with high heat. As illustrated in Injection Molding Handbook, 3^{rd} ed., D. V. Rosato, et. al., Kluwer Academic Publishers, pp. 895-896, typical drying times are 2-4 hours. The drying process is a separate step from other material processing and not typically considered “rapid”. Dew points down to minus 30 (−30) to minus 40 (−40) degrees Fahrenheit are employed. An example of extreme low free moisture is PET plastic that may contain about 0.05% free moisture when received and is dried to less than 0.005%. But again, this is accomplished with minus 40 (−40) degree Fahrenheit dry air combined with heating the material to 350 degree Fahrenheit. Drying times are measured in hours.

The current state of the art is that economics determine whether a product is dried either by heat or by dried air (or other medium such as nitrogen, etc.). Sometimes economics are superseded by technical requirements that necessitate low temperature drying. As documented in The Dehumidification Handbook, Second Edition, p. 56, Munters Corporation 2002, at about 120 degrees Fahrenheit and below, economics usually favor drying products by employing desiccated air. Above 120 degrees Fahrenheit, economics usually favor driving moisture off with heat. It is also well known that utilizing dry air in combination with a fluidized bed dryer can reduce the long drying times associated with fluidized bed drying; therefore, desiccated air is sometimes employed in combination with high temperatures to reduce drying time. However, even with the use of desiccated air and high temperatures, residence drying times of fluidized bed dryers can exceed several minutes, making such dryers unacceptable for applications where drying must occur over a short period of time.

A major challenge to drying any fine powder to extremely low free moisture levels is that the small particle size provides a large surface area in which moisture can adsorb. By providing an environment for the size reduction in which a very low moisture level (0.02 grains per pound of dry air or less) is present with the material, the water available for adsorption is limited. Furthermore, with the low water vapor pressure, moisture is drawn out of the material as its size is being reduced. Typically, drying applications that require “low free moisture” refers to products in a range of 1% to 10% free moisture. Extreme low free moisture applications such as the PET example discussed above, apply high temperature as well as desiccated air.

Current technologies do include low temperature, low humidity drying. However, the extremely low maximum free moisture of 0.04% is not typical for such a process. One knowledgeable in the drying of materials employing low temperature desiccated air is aware that such drying is generally conducted at near room temperature (approximately 70 degrees Fahrenheit) or lower. Typical items that are dried with this process are perishable foods, tobacco products, pharmaceuticals, and so forth. Residence times of the materials in this low temperature, low humidity environment is relatively long. Drying of these products can take hours or days. Even if this process could successfully be employed to dry trona ore, it would be an unacceptable long duration for processing bulk materials due to the high throughputs and short process residence times that are desired.

Another dryer technology in use is the pneumatic-conveyor dryer, also known as a flash dryer. In this process the size reduction step and the material drying step are distinct and separate, whereby material is introduced via a venturi into a hot conveying/drying air stream within a pneumatic conveying pipe. It should be noted that with this technology the feed material is subject primarily to constant rate drying, and the feed material must already be dewatered and have a low free moisture content. The material is conveyed pneumatically to a product collector, such as a cyclone separator, where the dried product is separated from the hot air stream. The conveying/drying pipe length is typically 50 pipe diameters long or less. As discussed in Kirk-Othmer Encyclopedia of Chemical Technology, 3^{rd} Ed., Volume 8, John Wiley & Sons, pp. 102-103, this technology allows for the solids feed into the venturi to replaced with a roller mill outlet. With the flash dryer, the material is usually broken up first to expose as much surface area of the particles before drying takes place to achieve uniform drying. For certain applications flash dryers are employed upstream of the mill. For example Kaolin clay is dried with high heat using before entering the mill. Also, certain industries have utilized flash dryers employing attenuated (i.e., low) heat. For example, sodium bicarbonate, a temperature sensitive material, is sometimes dried with flash dryers at temperatures as low as about 136 degrees Fahrenheit, but the air employed by the flash dryer is taken from an ambient source and is not conditioned or desiccated in any way.

Attempts have been made to dry trona ore powder having an initial free moisture below 0.50% but above 0.04% (in other words, with limited free moisture) with cool, desiccated air and a temperature slightly below the point of thermally damaging the trona. This has been attempted both in the storage silo and also in the pneumatic conveying lines. However, these efforts have not produced measurable reductions in free moisture.

Regardless of particle size, trona ore powder does not tend to rapidly liberate water just by exposing it to low humidity air. Some limited amount of heat energy must be employed to draw the moisture out of the pores and dry the trona ore. Yet this added heat energy must be low enough to avoid thermal damage to the trona ore product.

Limitations of the current method of producing a fine dry trona powder include a relatively slow drying time, difficulties consistently obtaining particle size below a D₅₀ of about 25 microns or less, difficulties consistently obtaining a free moisture of 0.04% or below, and milled powder adsorbing significant water vapor before the drying process begins.

Therefore, what is needed is a system and method for rapidly drying temperature sensitive hygroscopic materials that is faster than that currently known, will avoid moisture pick up after the size reduction step, and will produce a very fine powder with extremely low free moisture without the need for a separate drying step.

### SUMMARY OF THE INVENTION

The present invention is a system and method for rapidly processing materials possessing hygroscopic characteristics, particularly those materials that have an affinity to adsorb moisture from the environment when milled into a fine power. The present invention achieves simultaneous size reduction and drying of a temperature-sensitive hygroscopic material by introducing the hygroscopic material into size reduction equipment, introducing specially conditioned make-up air, and protecting the final product from moisture addition. The make-up air to the size reduction equipment is dehumidified to a very low absolute humidity (less than about 0.02 grains of water per pound of dry air), and heat addition (if needed) is controlled to below the temperature at which the hygroscopic material will incur adverse thermal effects known to be detrimental to its performance in end-use applications. The combination of desiccated air and low heat addition allows the free moisture in the hygroscopic material to desorb. Once liberated, the operation of the size reduction equipment allows the venting of a slipstream of moist air from the air stream, thereby maintaining a very low humidity level in the air stream entering the size reduction equipment.

The present invention is not limited to any one particular form of size reduction equipment and would be applicable to many types of reducing mills, including air swept mills, air attrition mills and pin mills, as well as other size reduction equipment. Furthermore, the present invention is not limited to any one particular material, although it is especially adapted to processes involving temperature sensitive, moisture adsorbing hygroscopic materials, such as sodium sesquicarbonate or trona ore.

An objective of the invention is to provide a system and method applicable to hygroscopic materials that will rapidly reduce a hygroscopic material to a fine powder having extremely low free moisture as one characteristic without requiring a separate drying step.

Another objective of the invention is to provide a system and method for rapidly reducing a hygroscopic material to a fine powder having extremely low free moisture and doing so at process temperatures below which thermal damage to the hygroscopic material is known to occur.

An additional objective of the invention is to provide a system and method for rapidly reducing a hygroscopic material to a fine powder that is optimal for applications, such as dry sorbent injection, that require a very fine product (D₅₀ less than approximately 15 microns), and an extremely low free moisture, while doing so at process temperatures below which thermal damage is known to occur.

Another additional objective of the present invention is to provide a system and method for rapidly reducing the particle size of a hygroscopic material to a fine powder without increasing free moisture.

Still another objective of the present invention is to provide a system and method for reducing the particle size of a hygroscopic material to a fine powder and in the same size reduction equipment reducing the free moisture value of the hygroscopic material to levels of 0.04% or less.

Yet another objective of the present invention is to provide a system and method for reducing the particle size of a hygroscopic material to a fine powder and in the same size reduction equipment reduce the free moisture to 0.04% or less, while doing so at temperatures below about 130 degrees Fahrenheit.

A further objective of the present invention is to provide a system and method for reducing the particle size of a hygroscopic material to a fine powder and in the same size reduction equipment reducing the free moisture to very low levels, and doing such at a temperature below about 130 degrees Fahrenheit, wherein the hygroscopic material is selected from the group consisting of trona, trona ore, and sodium sesquicarbonate.

A still further objective of the present invention is to provide a system and method for reducing the particle size of the hygroscopic material to a fine powder with a D₉₀ at or below about 45 microns and a D₅₀ below about 15 microns, and in the same size reduction equipment reducing the free moisture levels to 0.04% (by weight) or below, and doing such at a peak temperatures below about 130 degrees Fahrenheit, with the intention of avoiding thermal-induced damage, such as pre-calcination, of the hygroscopic material, where the hygroscopic material is a sodium product selected from the group consisting of trona, trona ore, and sodium sesquicarbonate.

Yet a further objective of the present invention is to provide a system and method of pretreating make-up air provided to a reducing mill utilized to mill or reduce a temperature sensitive, hygroscopic material by cooling, dehumidifying and, where necessary, reheating the make-up air to so as to result in make-up air conditions that are essentially 0% RH, meaning a dew point below minus 80 degrees Fahrenheit, or less than approximately 0.02 grains/lb of dry air, and to maximize the operating temperature of the mill without exceeding the temperature limit of the temperature sensitive, hygroscopic material.

### BRIEF DESCRIPTION OF THE DRAWINGS

FIG. 1 is a schematic of a typical reducing mill assembly that both reduces ore to a powder and is capable of drying materials utilizing high temperature heated make-up air.

FIG. 2 is a schematic of an embodiment of the present invention, whereby a typical reducing mill is modified to remove or disable equipment associated with providing heated make-up air, and adding equipment associated with providing desiccated make-up air having a maximum temperature of 130 degrees Fahrenheit or less.

FIG. 3 is a summary of data using trona ore obtained utilizing the system and method of the present invention.

### DETAILED DESCRIPTION OF THE PREFERRED EMBODIMENTS

Milling and drying temperature sensitive, hygroscopic materials in any standard configuration of reducing mill to produce a final product useful in dry sorbent injection system applications presents several challenges that the system and method of the present invention have overcome. Final particle size for dry sorbent injection system application must often be in the range of D₅₀ less than approximately 15 microns. In order to transport the hygroscopic material in a pneumatic conveying system without excessive fouling of the conveyor system components, the final product must be very dry in order to minimize cohesive forces inherent to very fine materials. The milling of hygroscopic materials into a fine powder has the undesirable side effect of creating a large surface area that is available for the adsorption of water vapor. The tendency of hygroscopic materials to adsorb moisture from its surrounding requires that the final product be transported in a controlled environment designed to minimize moisture adsorption. Additionally, hygroscopic materials that are also temperature sensitive, such as sodium sesquicarbonate or trona ore, can be rendered less effective by exposure to high temperatures during the milling process.

In order to address the need for a milling and conveying system that would meet the challenges of processing a temperature sensitive, hygroscopic material, a new approach to drying the material was needed. To achieve the necessary level of dryness, where free moisture is in the range of about 0.04% or below, without raising the temperature of the material to a level at which undesired chemical changes would begin to occur, the present invention employs alternative methods of pre-treating both the make-up air used in the milling or reducing process, and the transport air stream used to convey the finished product to storage for later packaging and use.

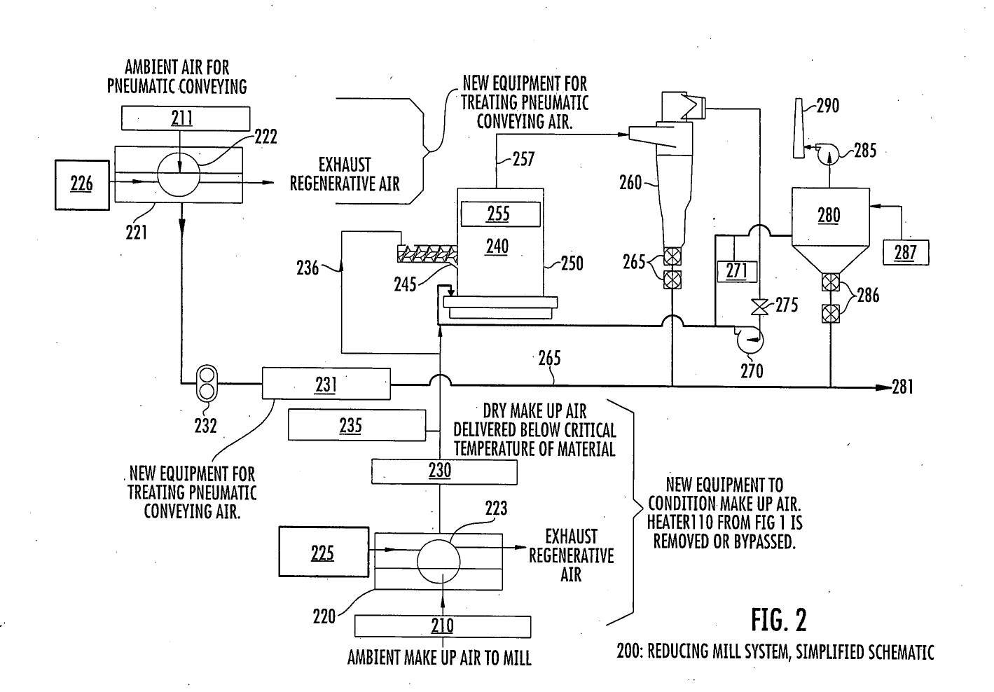

FIG. 2 illustrates an arrangement of an embodiment of the present invention, namely a reducing mill system (200) with desiccated, temperature-controlled make-up air and conditioned pneumatic conveying system that achieves the required level of dryness (free moisture level at or below about 0.04%) in a temperature sensitive, hygroscopic material without the disadvantages encountered using systems that employ high temperature pre-heating of the make-up air, namely early calcination of the material.

Raw material is supplied to reducing mill 240 by way of the material feed inlet 245 where it is directed to reducing mill body 250. Within reducing mill body 250, the milling or reduction process takes place by various methods depending on the type of reducing mill in use, but in general involving reducing or milling the raw material through a mechanical process of grinding, pulverizing, impacting, shredding, or crushing to produced a finished product. Reducing mill 240 is additionally equipped with classifier 255 where properly sized particles are discharged to the product side of reducing mill 240 and exit reducing mill 240 through reducing mill outlet 257 as finished product. Oversized particles are recycled to reducing mill body 250 where they reenter the milling or reducing process.

Returning to reducing mill 240, the drying of the raw material is conducted as the product is being milled. Operation of reducing mill 240 is controlled by way of the feed rate or throughput of raw material through material feed inlet 245 and the airflow to reducing mill 240. Typically, the processing rate (feed rate or throughput) through reducing mill 240 is governed by pressure drop across reducing mill 240 and its power consumption. Steady state conditions are achieved by establishing a constant feed rate and by modulating control damper 275 to maintain constant air flow to reducing mill 240. There are numerous alternate approaches to control airflow including controlling process fan 270 by way of a variable speed motor.

In an embodiment of the present invention, where the raw material is expected to be a hygroscopic material, such as sodium sesquicarbonate or trona ore, ambient air is supplied to reducing mill 240 as make-up air, and first enters air cooling unit 210, where the temperature of the make-up air is reduced to about between 40 to 50 degrees Fahrenheit as measured at the outlet of air cooling unit 210. Air cooling unit 210 is equipped with controls to avoid inadvertent freezing of coils should ambient air conditions already be at or even significantly below 40 degrees Fahrenheit. Depending upon ambient conditions, it is possible that the ambient air will drop below its water dew point resulting in water condensing out of the air stream. This has the desirable effect of lowering the water grain loading to the next step in the make-up air conditioning process, desiccant drier 220.

Desiccant drier 220 is equipped with rotating desiccant wheel 223, which is loaded full of desiccant material. Munters model number HCD 9000 is an example of a desiccant dryer employed for this application. As the make-up air passes through desiccant wheel 223, water vapor from the air stream is adsorbed into the pores of the desiccant material. As desiccant wheel 223 rotates, the desiccant material passes into a regenerative zone where a secondary air stream is heated by way of regenerative air heater 225 forming a regenerative air stream. This regenerative air stream is directed through desiccant wheel 223, where adsorbed water is liberated to the regenerative air stream and discharged with it to the atmosphere. Due to the absorption of residual heat from the regeneration air stream by desiccant wheel 223, when desiccant wheel 223 rotates into the path of the cooler make-up air stream, some of the heat held by desiccant wheel 223 will transfer to the make-up air, resulting in the temperature of the make-up air at the exit of desiccant drier 220 being higher than that at the inlet.

After exiting desiccant drier 220, the make-up air enters electric heater 230 with includes thermostatic controls. Electric heater 230 is energized only if the make-up air is judged to be below a predetermined optimum temperature. This optimum temperature selected so as to be the maximum temperature achievable without inducing thermal damage to the raw material being milled or reduced. An alternate configuration would be to have a second set of cooling coils acting as an aftercooler either in place of or after electric heater 230, to lower make-up air temperature depending upon the raw material being milled or reduced, and/or temperature influences from ambient conditions. Yet another alternate configuration is to have a different source of heat for electric heater 230, such as steam coils or indirect natural gas heat. The system of supplying make-up air to reducing mill 240 in the present invention is completed with the inclusion of monitoring instrumentation in the make-up airline, namely T/C and Humidity Monitor 235, which comprises a thermocouple and a dew point or other moisture measurement instrument. The sizing of air cooling unit 210, desiccant drier 220, and electric heater 230, should consider the meteorological extremes of both winter and summer operation as well as the maximum allowable temperature of the product being milled or reduced.

A slip stream of the make-up air is directed to Material Feed Inlet 245 as Dry Purge Air 236. This ensures that any tramp air entering the Reducing Mill 240 by way of the material feed is dried; thus minimizing moisture loading to the Reducing Mill 240. An alternate approach is to employ an air lock that greatly limits tramp air entering with the material. Regardless of the method chosen, it is important that any air entering the Reducing Mill 240 should be first dried to provide for an extremely dry environment within the mill.

Air exiting reducing mill 240 transports the finished product that passes through optional classifier 255 through reducing mill exit 257 and into cyclone separator 260 by way of a closed conduit, where most of the finished product (typically more than 90-95%) drops out of the air stream to the bottom of cyclone separator 260. Except for a slipstream of air and finished product directed to baghouse 280 as further explained below, the remaining air and generally less than 5% to 10% of residual finished product is recycled through process fan 270 and in turn to returns to reducing mill 240. Upstream of process fan 270 is control damper 275, which modulates the airflow to process fan 270 in order to maintain constant airflow to reducing mill 240. In an alternative embodiment, control damper 275 is located downstream of process fan 270.

At the outlet of process fan 270, a duct directs a slipstream of air and some residual finished product to baghouse 280. Thermocouple 271, monitors process temperature and can be used to control make-up air temperature. Baghouse 280, also known by those in the art as a fabric filter, is used to remove any remaining finished product from the air stream before it is discharged by way of baghouse fan 285 to stack 290 and released to the atmosphere. The air flow leaving the system by way of the slip stream out of baghouse 280 and stack 290 is balanced by the make up air that enters air cooling unit 210. In alternative embodiments of the present invention, cyclone separator 260 or baghouse 280 could be alternate particle separation devices, including electrostatic precipitators, hybrid collection devices that employ both electrostatic and filter media to separate particulate from the air stream, and multi-clones.

The present invention employs pulse air comprising dry compressed air 287 to clean the fabric filter within the baghouse 280, thereby minimizing the exposure of the product to water vapor. The equipment used to separate the particles from the air stream is not specific to the present invention; however, what is critical is that any air in contact with the finished product, such as pulse air in baghouse 280, be dry. Finished product that drops out of the air stream either in cyclone separator 260, or in baghouse 280, passes through air locks 265 and 286 respectively to pneumatic conveying line 265 for distribution to bulk storage vessels 281.

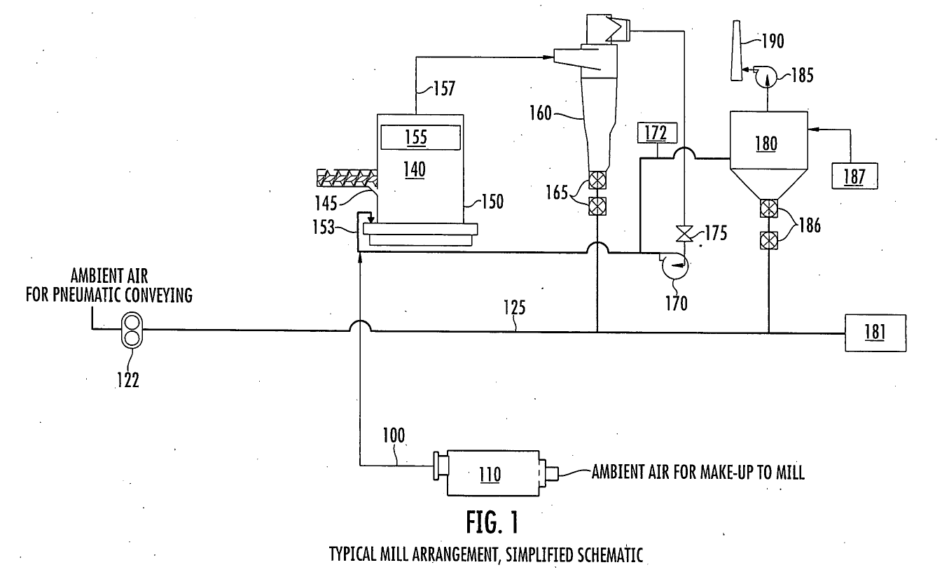

Pneumatic conveying line 265 of the present invention is similar to the pneumatic conveying line found in the typical reducing mill system with hot gas make-up air 100, illustrated in FIG. 1, but with the added condition that the air is now first pretreated by being cooled, and dried, as well as pressurized before coming in contact with the finished product. The pretreatment prevents damage to the temperature sensitive, dry material. The present invention employs an air-cooling unit 211 to lower the dew point of the transport air supplied to pneumatic conveying line 265 from ambient conditions to about 40 to 50 degrees Fahrenheit. This provides for some of the water vapor in the air to condense out thereby lowering the water vapor loading to desiccant dryer 221. Desiccant dryer 221 is comprised of desiccant wheel 222, and regenerative air heater 226. Cool, moist air from air-cooling unit 211 enters desiccant dryer 221, where it passes through desiccant wheel 222, which is loaded with desiccant material, resulting in water vapor being removed from the transport air stream. Desiccant wheel 222 rotates continuously between the transport air stream intended for pneumatic conveying line 265 and a regenerative air stream. The regenerative air stream is isolated from the transport air stream by seals.

The regenerative air stream takes a separate stream of ambient air, heats it to a predetermined temperature utilizing regenerative air heater 226. At the elevated temperature, the regenerative air stream passes through desiccant wheel 222 and drives off substantially all of the adsorbed water from the desiccant material held by desiccant wheel 222. This resulting moist regenerative air stream is exhausted to the atmosphere.

The transport air stream intended for pneumatic conveying line 265 exits desiccant drier 221 in an extremely dry condition, typically with a relative humidity approximately equal to 0%, and an absolute humidity approximately equal to 0.02 grains of water per pound of dry air. The transport air stream also picks up residual heat as it passes through desiccant wheel 222 due to being in constant contact with the elevated temperature of the regenerative air stream. The dry and now warm transport air stream then enters pneumatic conveying blower 232 where it is compressed. Leaving pneumatic conveying blower 232, the transport air stream is pressurized, dry, and relatively hot. The rise in transport air stream temperature comes from both the residual heat of desiccant drier 221 as well as the heat of compression across pneumatic conveying blower 232. Aftercooler 231 is used to remove the heat due to compression as well as residual heat from the regeneration mode of desiccant dryer 221 from the transport air stream, and is sized to ensure that the transport air stream exiting aftercooler 231 is at a temperature well below that where thermal damage could occur to the finished product it is intended to convey. Following its exit from aftercooler 231, the transport air stream is directed to pneumatic conveying line 265.

The cool dry transport air in pneumatic conveying line 265 conveys the finished product to bulk storage vessels 281. This may be a silo, a pneumatic truck or rail car, or other bulk storage vessel. Numerous alternate arrangements could be employed for the storage and transportation of the material, including having the finished product drop into packaging equipment directly or indirectly after being removed from the air stream at cyclone separator 260 or baghouse 280, or dropping into a system of alternate conveying equipment. What is key is that after the raw material is milled, any equipment used in the processing, handling, logistics, or for any other purpose, must maintain the material both a cool and dry condition.

### Illustrative Examples

The difference in results achieved by system of FIG. 1 and that of the present invention are best illustrated by tests performed utilizing trona ore in both configurations.

### Example 1

### Typical Milling Arrangement of FIG. 1

Referring once again to FIG. 1, trona ore was used to test the results of milling or reducing a temperature sensitive, hygroscopic material in a typical mill arrangement where high temperature gases, in this case heated air, are used to facilitate rapid drying of the raw material during the milling or reducing process. Laboratory tests of the configuration of FIG. 1, began with the milling of raw material without utilizing heater 110. Since the free moisture of the raw material was not thought to be very high, reducing mill 140 was first operated without the use of any ancillary equipment to drive off moisture. This resulted in a finished product that significantly exceeded maximum free moisture levels of 0.04% free moisture.

Attempts In the laboratory to employ the standard methods of drying the material within the roller mill were also not successful. The typical method for drying raw material in a reducing mill is a heater. The heater raises the internal temperature of the reducing mill and the raw material by introducing a hot make-up air stream. Although results indicated the reducing mill was capable of producing an acceptably small particle size, thermal damage to the trona ore was detected any time heater 110 was employed. In addition, as the temperature was raised to drive off more free moisture, the opposite effect was seen. Instead, there was an increase in free moisture in the finished product. Evidence points to water being released as a result of the partial calcination of the trona ore (thermal damage), a condition that is highly undesirable for applications in which the milled trona ore was to be used in dry sorbent injection systems. The heater employed may also have contributed to the free moisture of the product, since it was a direct-fired natural gas heater. Products of combustion include water which became part of the make up air and likely contributed to the particle free moisture. However, even an indirect-fired heater would have been unacceptable since thermal damage was noted.

Thermal damage to trona resulting from chemical degradation to soda ash due to complete or partial calcination, can be detected by chemical analysis of the finished product. Theoretical sodium bicarbonate content is 37.17%; sodium carbonate content is 46.90%. The theoretical ratio of HCO₃:CO₃ is 0.7925. Laboratory tests results in those instances where natural gas heating was used show evidence of thermal damage, in the form of calcination, due to the reduced HCO₃ content as compared to non-calcined samples. Despite the instances of thermal damage from use of heater 110, the overall performance of the reducing mill in size reduction was considered acceptable for dry sorbent injection.

Observations indicate that calcination of trona ore can begin at temperatures above 125 degrees Fahrenheit according to the following reaction:

2Na₂CO₃.NaHCO₃.2H₂O+Heat→3Na₂CO₃+CO₂+5H₂O

It was readily observed that even incomplete calcination releases an unacceptable amount of water resulting in high free moisture content in the finished product. Further laboratory experimentation detected calcination of the trona ore in instances where the inlet make-up air temperature was 230 degrees Fahrenheit and the exit air temperature was 130 degrees Fahrenheit. Make-up air was only about 10% to 15% of the entire circulating airflow. It was presumed at the time of testing that the dilution of the make-up air with the main air stream (upstream of the mill inlet) would be sufficient to avoid any thermal damage to the product.

After determining that operating reducing mill 140 both with and without heater 110 was unsuccessful, a tertiary approach was employed. An attempt was made to warm up the mill using heater 110 prior to the introduction of the trona ore. Heater 110 was employed and successfully heated the mill inlet and outlet temperatures. Operation of heater 110 was then terminated to eliminate the products of combustion, namely water vapor originating from the direct-fired gas unit and to eliminate any potential hot spots of air being introduced into reducing mill 140. After heater 110 was removed from operation, and the temperature of reducing mill 140 was relatively stable, the trona ore was feed to reducing mill 140 by way of raw material feed 140. Even under these conditions, tests of the finished product showed free moisture significantly exceeded the maximum allowable limit of 0.04%. Furthermore, in all cases where heater 110 was employed the raw material became at least locally overheated resulting in partial calcination of the trona finished product.

### Example 2

### System of the Present Invention

Following the unsatisfactory results of the laboratory tests described in Example 1 above, the principals of the present invention were applied to a field test of a 66-inch Raymond, vertical ring, air swept roller mill. FIG. 2 shows the arrangement of the equipment utilized during the field test. Once again, trona ore was selected as the raw material.

The required level of drying required to reduce the free moisture content of the milled trona ore to 0.04% (by weight) or lower, without exceeding the calcinations temperature, was achieved by modifying the pretreatment system in the make-up air supply to reducing mill 240. In particular, instead of preheating the make-up air to a high temperature using a natural gas or electric heater, the make-up air was cooled, dehumidified, and, when necessary, reheated to a value equal to or below a predetermined critical temperature. The intent was to provide make-up air that was essentially at 0% relative humidity, defined as having a dew point below minus 90 (−90) degrees Fahrenheit, or less than approximately 0.02 grains per pound of dry air, and to maximize the operating temperature of the mill without exceeding the low calcination temperature. The dried, temperature controlled air was fed directly into reducing mill 240. The critical temperature was determined to be between 100 and 125 degrees Fahrenheit in order to avoid calcinations of the trona ore. This temperature range was found to promote surface moisture removal from the trona ore to levels consistently at or below 0.04% when the drying parameters are properly controlled.

When trona ore is dried to free moisture levels of 0.04% or below, the milled trona ore is free flowing and easily handled. A lapse in drying control may first be noted in material handling within the reducing mill circuit. High levels of moisture will increase the cohesive nature of trona and could promote fouling of the reducing mill passages. Small increases in moisture content, such as at free moisture levels above 0.04%, tend to be characterized by material handling problems, such as the appearance of plugging or “rat holes” in the bulk storage vessels and/or the injection system.

To demonstrate the effect of the modifying the make-up air pretreatment system, testing was conducted utilizing the arrangement of FIG. 2. Operating parameters for reducing mill 240 included maintaining a make-up air temperature of about 117 to 122 degrees Fahrenheit; limiting the maximum make-up air dew point temperature to about minus 90 (−90) degrees Fahrenheit, or an absolute humidity below 0.02 grains water per pound of dry air; operating reducing mill 240 at a speed of about 416 revolutions per minute; operating classifier 255 at a speed of about 377 revolutions per minute; maintaining reducing mill 240 differential pressure at approximately 8.5 to 10 inches water column; and achieving a mill production rate, or mill throughput, of between 8 to 12 tons per hour.

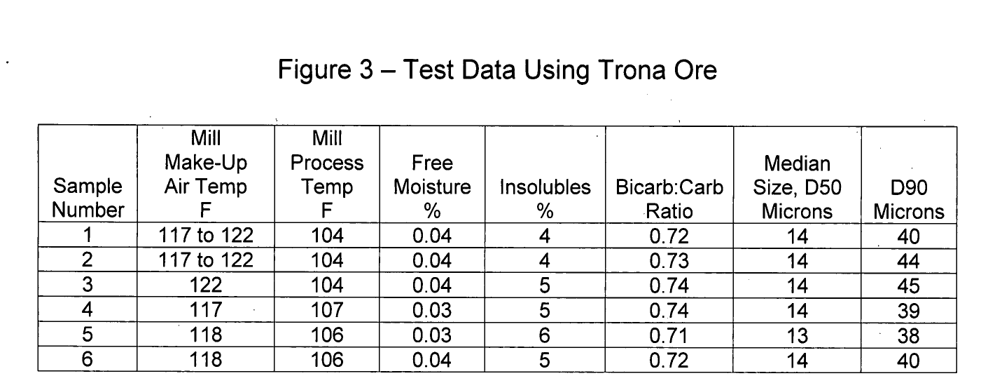

Once the operating parameters were established, a long production run of about eight hours or more took place. Samples were taken at various times throughout the production run and these are tabulated in FIG. 3. From this data it can be seen that trona ore can be both finely milled to a D₅₀ less than about 15 microns, while achieving a free moisture levels at or below 0.04% (by weight) without having to utilize a secondary drying process.

While the preceding discussion has used sodium sesquicarbonate, or trona ore as illustrative of the benefits of the present invention, such usage is by no means intended to limited the application of the claims of present invention to just those materials. Those skilled in the art will recognize that the present invention is applicable to many hygroscopic materials, including, but not limited to various hygroscopic plastics, as well as Nahcolite (natural sodium bicarbonate ore). In addition, the present invention is also applicable to flash driers to allow low temperature drying in equipment that was originally design for high temperature applications. This would allow more varied hygroscopic materials to be dried using flash dryers.

I claim:

1. A method for pretreating make-up air to a reducing mill to provide for both the milling and the rapid drying of a raw material having a chemical affinity to absorb moisture in fine particle form, the method comprising:
a. pretreating the make-up air to the reducing mill to reduce the moisture content of the make-up air to a predetermined maximum relative humidity value,
wherein the maximum relative humidity value is selected by taking into consideration the material handling characteristics of the raw material;
b. further pretreating the make-up air to the reducing mill to limit the temperature of the make-up air at the inlet of the reducing mill to a predetermined maximum temperature, wherein the maximum temperature is selected by taking into account the chemical characteristics of the material.

2. The method of claim 1, wherein the pretreating to reduce the moisture content and limit the temperature of the make-up air is accomplished by passing the make-up air through an air cooling unit and then through a desiccant air dryer before introducing the make-up air into the body of the reducing mill.

3. The method of claim 2, wherein, if the make-up air exiting the desiccant air drying is below a first predetermined temperature, the make-up is first directed through a preheating unit and heated to a second predetermined temperature before being introduced into the body of the reducing mill.

4. A system for milling and rapidly drying a raw hygroscopic material at low temperature, the system comprising:
a. A reducing mill having a mill body, a first inlet for the introduction of the raw hygroscopic material into the mill body, a second inlet for introduction of make-up air into the mill body, a reducing means for reducing the size of the raw hygroscopic material, a classifier for separating milled hygroscopic material having an average particle size less than or equal to a predetermined size from milled hygroscopic material having an average particle size greater than such predetermined size, and an outlet wherein the milled hygroscopic material having an average particle size less than our equal to the predetermined value exits the reducing mill entrained in the make-up air; and
b. a make-up air pretreatment system for pretreating the make-up air supplied to the reducing mill by removing substantially all of the free moisture from the make-up air and controlling the temperature of the make-up air delivered to the reducing mill within a predetermined range.

5. The system of claim 4, wherein the make-up air pretreatment system comprises an air cooling unit and a desiccant air dryer.

6. The method of claim 4, wherein the first inlet and the second inlet merge together to form a single inlet prior to the raw hygroscopic material and the make-up air entering the mill body.
